(19) United States
(12) Patent Application Publication
(10) Pub. No.: US 2021/0055687 A1
(43) Pub. Date: Feb. 25, 2021

(54) IMAGE FORMING APPARATUS AND METHOD FOR CONTROLLING IMAGE FORMING APPARATUS

(71) Applicants: Shinichi KAWABATA, Hino-shi (JP); Kanehiro WATANABE, Sagamihara-shi (JP)

(72) Inventors: Shinichi KAWABATA, Hino-shi (JP); Kanehiro WATANABE, Sagamihara-shi (JP)

(21) Appl. No.: 16/926,255

(22) Filed: Jul. 10, 2020

(30) Foreign Application Priority Data
Aug. 19, 2019 (JP) 2019-149613

(51) Int. Cl. G03G 21/20; G03G 15/20

(52) U.S. Cl. CPC G03G 21/206; G03G 15/2053; G03G 15/2017

(57) ABSTRACT

An image forming apparatus includes: an image former that forms a toner image; a fixing device that fixes the toner image to a sheet onto which the toner image formed by the image former has been transferred; a housing that houses the image former and the fixing device; an air supply fan that supplies air into the housing; an exhaust fan that exhausts air from the housing; and a hardware processor that controls driving of the image former, the fixing device, the air supply fan, and the exhaust fan, wherein when the driving of the air supply fan is changed, the hardware processor changes a blowing capacity of the exhaust fan in accordance with the change in the driving of the air supply fan.

The entire disclosure of Japanese patent Application No. 2019-149613, filed on Aug. 19, 2019, is incorporated herein by reference in its entirety.

### BACKGROUND

### Technological Field

The present invention relates to an image forming apparatus and a method for controlling the image forming apparatus.

### Description of the Related art

An electrophotographic image forming apparatus includes a fixing device for fixing a toner image onto a sheet as a recording medium by applying heat and pressure thereto. As a technique related to such an image forming apparatus, a configuration in which a duct for releasing heat generated by a thermal fixing unit is disposed between the image forming unit and the thermal fixing unit (fixing device) is disclosed in JP 2011-221279 A. This duct has an exhaust fan disposed at one end, and exhausts the heated air from the inside of the duct and the apparatus, to release the heat from the inside of the duct and the apparatus.

Meanwhile, an electrophotographic image forming apparatus is equipped with air supply fans for supplying air into the apparatus, such as a separation fan for blowing air to separate a sheet from the fixing device, and a cooling fan for the belt cleaning device.

However, in a case where all of these air supply fans are driven simultaneously, the emission of a certain volume of air from the duct is not sufficient as the emission volume in the apparatus, and heat accumulates in the apparatus, to cause a temperature rise. This temperature rise results in damage to components in the apparatus and melting of toner in the image forming unit.

### SUMMARY

Therefore, an object of the present invention is to provide an image forming apparatus capable of preventing a temperature rise in the housing by releasing heat without allowing heat accumulation in the housing in a case where the air supply fans that supply air into the housing of the apparatus are driven, and a method for controlling the image forming apparatus.

To achieve the abovementioned object, according to an aspect of the present invention, an image forming apparatus reflecting one aspect of the present invention comprises: an image former that forms a toner image; a fixing device that fixes the toner image to a sheet onto which the toner image formed by the image former has been transferred; a housing that houses the image former and the fixing device; an air supply fan that supplies air into the housing; an exhaust fan that exhausts air from the housing; and a hardware processor that controls driving of the image former, the fixing device, the air supply fan, and the exhaust fan, wherein when the driving of the air supply fan is changed, the hardware processor changes a blowing capacity of the exhaust fan in accordance with the change in the driving of the air supply fan.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic configuration diagram of an image forming apparatus according to a first embodiment as viewed from the front side;

FIG. 2 is a configuration diagram of the relevant components of the image forming apparatus according to the first embodiment, as viewed from the sheet ejection side;

FIG. 3 is a diagram for explaining a method for controlling the image forming apparatus according to the first embodiment;

FIG. 4 is a schematic view of the entire configuration of an image forming apparatus according to a second embodiment;

FIG. 5 is a schematic view of the entire configuration of an image forming apparatus according to a third embodiment;

FIG. 6 is a schematic view of the entire configuration of an image forming apparatus according to a fourth embodiment; and

FIG. 7 is a configuration diagram of the relevant components of the image forming apparatus according to the fourth embodiment, as viewed from the sheet ejection side.

### DETAILED DESCRIPTION OF EMBODIMENTS

Hereinafter, one or more embodiments of the present invention will be described with reference to the drawings. However, the scope of the invention is not limited to the disclosed embodiments. Note that like components are denoted by like reference numerals in the respective embodiments, and the same explanation will not be repeated.

### First Embodiment

### Configuration of an Image Forming Apparatus

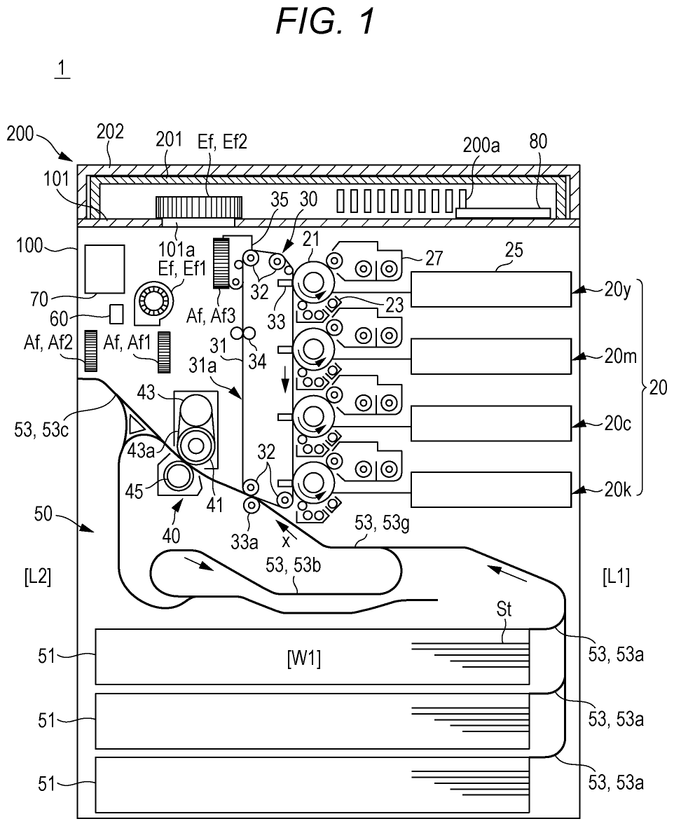

FIG. 1 is a schematic configuration diagram of an image forming apparatus 1 according to a first embodiment as viewed from the front side [W1]. The front side [W1] is the side facing the operator who operates the image forming apparatus 1. The image forming apparatus 1 shown in this drawing is an electrophotographic system that forms a toner image on a sheet St as a recording medium, and includes a housing 100, a ceiling housing 200, an image former 20, a transferrer 30, a fixing device 40, and a sheet feeder 50. The image forming apparatus 1 also includes a plurality of air supply fans Af and a plurality of exhaust fans Ef. The image forming apparatus 1 further includes temperature sensors 60, a controller 70 connected to each of these components, and an operation unit 80 connected to the controller 70.

In FIG. 1, the right-hand side in the drawing is the sheet supply side [L1], and the left-hand side in the drawing is the sheet ejection side [L2]. Here, the sheet ejection side [L2] is the side on which each sheet St is ejected from the housing 100. The opposite side from the sheet ejection side [L2] is the sheet supply side [L1].

In the description below, the respective components constituting the image forming apparatus 1 will be sequentially described in detail, starting from the configurations of the housing 100 and the ceiling housing 200.

### Housing 100

The housing 100 has a box-like shape. The box-like housing 100 has a door (not shown in the drawing) disposed on the front side [W1], and the door is opened so that the housing 100 is replenished with sheets St, or maintenance is performed.

The top panel 101 that forms the ceiling face of the housing 100 also serves as the bottom panel of the ceiling housing 200. Such a top panel 101 separates the housing 100 from the ceiling housing 200. Further, an opening 101a is formed in the top panel 101, and the inside of the housing 100 and the inside of the ceiling housing 200 communicate with each other through the opening 101a. The formation position of the opening 101a in the top panel 101 is above the fixing device 40, which will be described later, and is preferably near the front side [W1] of the housing 100, for example. In this example, the formation position of the opening 101a is closer to the front side [W1] than the intermediate position between the front side [W1] and the back side on the opposite side of the housing 100 from the front side [W1].

### Ceiling Housing 200

The ceiling housing 200 is a box-like housing that is disposed on top of the housing 100. The ceiling housing 200 is arranged at a position that covers at least the opening 101a of the top panel 101. Such a ceiling housing 200 includes an external top panel 201 designed to form an internal space between the top panel 101 and the external top panel 201, and an external cover 202 that covers the external top panel 201. Exhaust holes 200a communicating with the outside are formed in the external top panel 201 and the external cover 202.

With this arrangement, the inside of the housing 100 communicates with the outside through the opening 101a of the top panel 101, the inside of the ceiling housing 200, and the exhaust holes 200a. Note that the exhaust holes 200a are located on the back side that is the opposite side of the ceiling housing 200 from the front side {W1], or is located closer to the back side than the intermediate position between the front side [W1] and the back side on the opposite side of the ceiling housing 200 from the front side [W1] in the housing 100, for example.

### Image Former 20

The image former 20 includes four image forming units 20y, 20m, 20c, and 20k for forming toner images in the respective colors of yellow (Y), magenta (M), cyan (C), and black (K), for example. These image forming units 20y, 20m, 20c, and 20k are vertically stacked in the housing 100, and each of the image forming units 20y, 20m, 20c, and 20k includes a photoconductor 21, a charger 23 disposed near the photoconductor 21, an exposure unit 25, and a developing unit 27.

Of these components, the photoconductor 21 is a drum-like component that is rotated by a drive motor, and the peripheral surface of the drum-like component serves as the image bearing surface on which a toner image is formed. The drum-like photoconductor 21 is disposed almost horizontally from the front side [W1] of the housing 100 toward the back side. In the vicinity of the photoconductor 21, the charger 23, the exposure unit 25, and the developing unit 27 are arranged in this order from the upstream side in the rotating direction of the photoconductor 21.

The image bearing surface of the photoconductor 21 is uniformly charged by the charger 23, and an electrostatic latent image is formed on the charged image bearing surface through exposure scanning performed by the exposure unit 25. Note that the exposure scanning by the exposure unit 25 is performed on the basis of image data received from an external device, for example.

The developing unit 27 supplies electrically charged toner to the image bearing surface of the photoconductor 21 having the electrostatic latent image formed thereon, so that the corresponding color toner adheres to the electrostatic latent image formed on the image bearing surface of the photoconductor 21. As a result, a yellow toner image is formed on the image bearing surface 21a of the photoconductor 21 in the image forming unit 20y, a magenta toner image is formed on the surface of the photoconductor 21 in the image forming unit 20m, a cyan toner image is formed on the photoconductor 21 in the image forming unit 20c, and a black toner image are formed on the photoconductor 21 in the image forming unit 20k.

The image forming units 20y, 20m, 20c, and 20k designed as described above are arranged so that the respective axes of the photoconductors 21 extend parallel to one another. In this arrangement, the image bearing surface of each photoconductor 21 faces in the same direction between the developing unit 27 and the charger 23 in each photoconductor 21.

### Transferrer 30

The transferrer 30 is disposed in parallel with the image former 20 in the housing 100. The transferrer 30 includes an intermediate transfer belt 31 designed as a rotating endless belt, and a plurality of rollers 32 and primary transferrers 33 that are in contact with the inner face of the intermediate transfer belt 31. The transferrer 30 also includes a secondary transfer roller 33a, neutralization rollers 34, and a cleaning unit 35. These components are disposed almost horizontally from the front side [W1] of the housing 100 toward the back side.

Of these components, the intermediate transfer belt 31 is disposed so as to rotate in the vertical direction while being stretched over the plurality of rollers 32, and the outer circumferential surface thereof serves as an image bearing surface 31a. Such an intermediate transfer belt 31 rotates in a direction opposite from the rotation of each photoconductor 21 of the image forming units 20y, 20m, 20c, and 20k, and is in such a state that the image bearing surface 31a sequentially comes into contact with all of the photoconductors 21.

The plurality of rollers 32 is disposed on the inner circumferential side of the intermediate transfer belt 31 so that the image bearing surface 31a of the intermediate transfer belt 31 comes into contact with all the photoconductors 21. One of these rollers 32 is designed as a driving roller for rotating the intermediate transfer belt 31.

The primary transferrers 33 are located on the inner circumferential side of the intermediate transfer belt 31 so that the intermediate transfer belt 31 is interposed between the respective photoconductors 21 and the primary transferrers 33 at respective positions facing the photoconductors 21 of the image forming units 20y, 20m, 20c, and 20k. A voltage having a polarity that is the opposite of the polarity of the toner is applied to these primary transferrers 33, so that the toner attached to the image bearing surface of each photoconductor 21 is transferred onto the image bearing surface 31a of the intermediate transfer belt 31.

Meanwhile, the secondary transfer roller 33a is disposed under the intermediate transfer belt 31 at a position facing one of the rollers 32, with the intermediate transfer belt 31 being interposed between the one roller 32 and the secondary transfer roller 33a. The nip portion at which the secondary transfer roller 33a and the roller 32 are in contact with each other is the transfer position at which the toner image formed on the image bearing surface 31a of the intermediate transfer belt 31 is transferred onto a sheet St conveyed from the sheet feeder 50 described later.

Further, the neutralization rollers 34 are disposed on the downstream side of the secondary transfer roller 33a and on the upstream side of the primary transferrers 33 in the rotating direction of the intermediate transfer belt 31, with the intermediate transfer belt 31 being interposed between the neutralization rollers 34. The neutralization rollers 34 eliminate the electric charge of the intermediate transfer belt 31.

The cleaning unit 35 is disposed at a position that is on the outer circumferential side of the intermediate transfer belt 31 between the neutralization rollers 34 and the primary transferrers 33, and is above the fixing device 40. In this arrangement, the cleaning unit 35 faces the image bearing surface 31a of the intermediate transfer belt 31. The cleaning unit 35 is designed for removing and collecting the toner remaining on the image bearing surface 31a of the intermediate transfer belt 31.

### Fixing Device 40

The fixing device 40 is disposed below the cleaning unit 35 in the housing 100 and is on the downstream side of the secondary transfer roller 33a in the transferrer 30 with respect to the conveyance direction x of the sheet St conveyed from the sheet feeder 50 described later. The fixing device 40 includes a heating roller 41, a driving roller 43, and a pressure roller 45. These components are disposed almost horizontally from the front side [W1] of the housing 100 toward the back side.

The heating roller 41 includes a heating control means, for example. The driving roller 43 has a configuration in which a fixing belt 43a is stretched between the driving roller 43 and the heating roller 41, and rotates the heating roller 41 via the fixing belt 43a. The pressure roller 45 forms a nip portion that nips the sheet St between the pressure roller 45 and the heating roller 41 via the fixing belt 43a.

The fixing device 40 having such a configuration presses and heats the sheet St conveyed from the secondary transfer roller 33a, to fix the toner image transferred onto the sheet St, to the sheet St.

### Sheet Feeder 50

The sheet feeder 50 is disposed in the housing 100, and includes a plurality of supply trays 51 and a conveyance path 53 that conveys sheets St. Of these components, the plurality of supply trays 51 is provided in accordance with the sizes and the types of the sheets St. Each supply tray 51 stores sheets St, and supplies the stored sheets St to the conveyance path 53 one by one.

The conveyance path 53 includes individual conveyance paths 53a that convey sheets St supplied from the respective supply trays 51 one by one to the secondary transfer roller 33a. The conveyance path 53 further includes a reversing conveyance path 53b that reverses the sheet St that has passed through the fixing device 40, and supplies the reversed sheet St to the secondary transfer roller 33a.

These individual conveyance paths 53a and the reversing conveyance path 53b are merged on the upstream side of the secondary transfer roller 33a, and the sheet St is supplied to the secondary transfer roller 33a by the merged conveyance path 53g. Note that the conveyance path 53 also includes an ejection path 53c for ejecting the sheet St that has passed through the fixing device 40 from the housing 100.

The sheet feeder 50 as described above supplies and conveys each sheet St along the front side [W1] of the housing 100.

### Air Supply Fans Af

The air supply fans Af are fans for supplying air into the housing 100 of the image forming apparatus 1, and is driven primarily when an image formation job is executed. Such air supply fans Af are disposed at a plurality of locations inside the housing 100, or particularly, at a plurality of positions near the fixing device 40. The plurality of air supply fans Af disposed near the fixing device 40 are a separation fan Af1, a sheet cooling fan Aft, and a cleaning unit cooling fan Af3. Note that each of these air supply fans Af is connected to a duct (not shown in the drawing), or is disposed at the middle of the duct and supplies air from outside the housing 100 to the respective positions in the housing 100. Next, each of these air supply fans Af is described.

### Separation Fan Af1

The separation fan Af1 is for separating a sheet St from the fixing belt 43a of the fixing device 40 by blowing air. Such a separation fan Af1 is disposed on the downstream side of the fixing device 40, for example, and the air supply end side of the duct (not shown) is disposed close to the ejected portion of the sheet St from the fixing device 40. Alternatively, a plurality of separation fans Af1 may be provided for the fixing device 40.

Here, the separation fan Af1 might not need to be driven in executing an image formation job, depending on the rigidity of the sheet St. Specifically, since a sheet St having a low rigidity due to a small thickness and a material having no rigidity easily adsorbs to the fixing belt 43a of the fixing device 40, it is necessary to separate the sheet St from the fixing belt 43a with air blown from the separation fan Af1. On the other hand, a sheet St having a high rigidity due to a great thickness and a material having a high rigidity does not easily adsorb to the fixing belt 43a of the fixing device 40, and is separated from the fixing belt 43a without any air blown from the separation fan Af1. Therefore, in a case where the target sheet St in image formation has rigidity, the separation fan Af1 may not be driven in the execution of the image formation job.

### Sheet Cooling Fan Af2

The sheet cooling fan Af2 is for supplying air to cool a sheet St ejected while being heated by the fixing device 40. Such a sheet cooling fan Af2 is disposed in the vicinity of the ejection path 53c of the sheet feeder 50, for example, and the air supply end side of the duct (not shown) is positioned so as to blow air toward the ejection path 53c. Alternatively, a plurality of sheet cooling fans Af2 may be provided for the ejection path 53c.

### Cleaning Unit Cooling Fan Af3

The cleaning unit cooling fan Af3 is for cooling the cleaning unit 35 disposed in the transferrer 30. Such a cleaning unit cooling fan Af3 is disposed in the vicinity of the cleaning unit 35 in the transferrer 30, and the air supply end side of the duct (not shown) is positioned so as to blow air toward the cleaning unit 35. Alternatively, a plurality of cleaning unit cooling fans Af3 may be provided for the cleaning unit 35.

### Exhaust Fans Ef

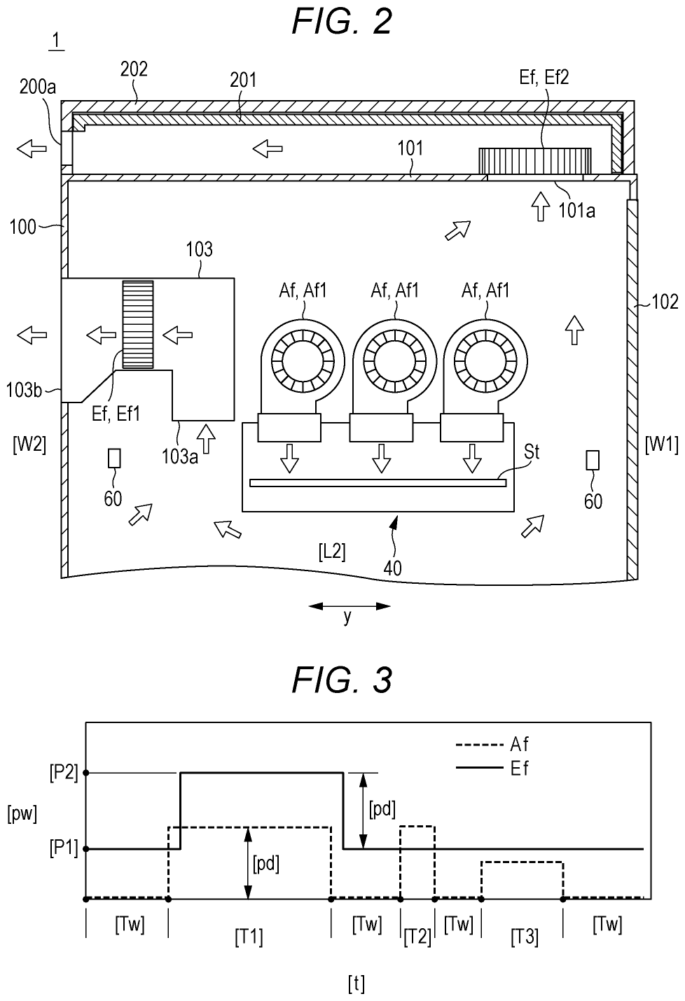

FIG. 2 is a configuration diagram of the relevant components of the image forming apparatus 1 of the first embodiment as viewed from the sheet ejection side [L2], and is a diagram for explaining the layout of the exhaust fans Ef. In FIG. 2, the right-hand side of the housing 100 is the front side [W1] of the housing 100, and is the side on which a door 102 is formed. Also, in FIG. 2, the left-hand side of the housing 100 is the opposite side from the front side [W1], and is the back side [W2] of the housing 100. The direction from the front side [W1] toward the back side [W2] is the conveyance width direction y of the sheet St perpendicular to the conveyance direction x of the sheet St. FIG. 2 shows part of the duct 103, which is not shown in FIG. 1, and indicates the airflow with arrows. In the description below, the configurations of the exhaust fans Ef are explained, with reference to FIGS. 1 and 2.

The exhaust fans Ef are fans for exhausting the air in the vicinity of the fixing device 40 in the housing 100 of the image forming apparatus 1, to the outside of the housing 100. Such exhaust fans Ef are disposed in the housing 100 and in the ceiling housing 200. Such exhaust fans Ef include an internal exhaust fan Ef1 disposed in the housing 100, and a ceiling exhaust fan Ef2 disposed in the ceiling housing 200, for example. Alternatively, a plurality of internal exhaust fans Ef1 and a plurality of ceiling exhaust fans Ef2 may be provided.

### Internal Exhaust Fan Ef1

In the housing 100, the internal exhaust fan Ef1 is disposed on one end side in the conveyance width direction y perpendicular to the conveyance direction x of the sheet St, and is on the back side [W2] of the housing 100. With this arrangement, the installation of the internal exhaust fan Ef1 does not hinder maintenance that is performed with the door 102 open. The internal exhaust fan Ef1 is disposed at the middle of the duct 103 as shown in the drawing, for example, or is disposed at an end of the duct 103, to exhaust the air around the fixing device 40 from the housing 100.

Specifically, the duct 103 equipped with the internal exhaust fan Ef1 has an air intake end 103a disposed near the back side [W2] of the fixing device 40 in the housing 100. That is, the intake end 103a of the duct 103 is positioned closer to the back side [W2] than the intermediate position between the front side [W1] and the back side [W2] of the housing 100. The duct 103 also has an air release end 103b located in the surface of the housing 100 on the back side [W2] so as to communicate with the outside of the housing 100. With this arrangement, in a case where the internal exhaust fan Ef1 is driven, the air near the fixing device 40 is sucked from the back side [W2] of the housing 100, and is released from the surface on the back side [W2] of the housing 100 to the outside.

The internal exhaust fan Ef1 disposed in this manner preferably has a blowing capacity that can be adjusted stepwise, but does not necessarily have such a blowing capacity. Further, in a case where a plurality of internal exhaust fans Ef1 is adopted, the internal exhaust fans Ef1 may be arranged either in parallel or in series.

### Ceiling Exhaust Fan Ef2

In the ceiling housing 200, the ceiling exhaust fan Ef2 is disposed to face the opening 101a in the top panel 101. With this arrangement, the installation of the internal exhaust fan Ef1 does not hinder maintenance that is performed with the door 102 open. The ceiling exhaust fan Ef2 uses the ceiling housing 200 as a duct, takes in the air in the housing 100 through the opening 101a in the top panel 101, and exhausts the air from the housing 100 to the outside of the housing 100 through the exhaust holes 200a formed in the ceiling housing 200. In the top panel 101, the opening 101a is located at a position that is above the fixing device 40 and is close to the front side [W1] of the housing 100.

With this arrangement, in a case where the ceiling exhaust fan Ef2 is driven, the air near the fixing device 40 is sucked from the front side [W1] of the housing 100, and is released from the exhaust holes 200a to the outside on the back side [W2] via the ceiling housing 200.

The ceiling exhaust fan Ef2 is driven at the same time as the internal exhaust fan Ef1 that sucks the air near the fixing device 40 from the back side [W2] of the housing 100, so that the air near the fixing device 40 can be sucked more evenly in the conveyance width direction y. For this reason, the heat emission in the vicinity of the fixing device 40 and the temperature adjustment in the fixing device 40 by the heat emission become more evenly in the conveyance width direction y, and thus, the fixing of a toner image onto the sheet St by the fixing device 40 can be made uniform in the conveyance width direction y. As a result, a toner image can be fixed to the sheet St in the conveyance width direction y without unevenness.

The ceiling exhaust fan Ef2 described above preferably has a blowing capacity that is equal to or higher than the total blowing capacity of the air supply fans Af, for example. Further, the blowing capacity is preferably adjustable stepwise, but the present invention is not limited to this.

Note that the ceiling exhaust fan Ef2 is not necessarily disposed to face the opening 101a in the top panel 101. That is, the ceiling exhaust fan Ef2 may have any appropriate configuration, as long as the air taken in through the opening 101a can be released through the exhaust holes 200a, with the ceiling housing 200 being used as a duct. Further, in a case where a plurality of ceiling exhaust fans Ef2 is adopted, the ceiling exhaust fans Ef2 may be arranged either in parallel or in series.

### Temperature Sensors 60

The temperature sensors 60 are disposed on the front side [W1] and on the back side [W2] in the housing 100, for example. These temperature sensors 60 may be disposed near the fixing device 40, or may be disposed above the fixing device 40 and near the cleaning unit 35, for example. The temperature sensors 60 may be provided only at a position close to the fixing device 40, or may be provided only at a position above the fixing device 40 and close to the cleaning unit 35.

### Controller 70

The controller 70 shown in FIG. 1 controls driving of the image former 20, the transferrer 30, the fixing device 40, the sheet feeder 50, the air supply fans Af, and the exhaust fans Ef, in accordance with an operation at the operation unit 80. A toner image is then formed on a sheet St. The controller 70 may also control driving of the air supply fans Af and the exhaust fans Ef, by referring to temperature information from the temperature sensors 60. The controller 70 as described above is formed with a computer such as a microcomputer. The computer includes a central processing unit (CPU), a read only memory (ROM), and a random access memory (RAM).

In particular, the controller 70 characteristically controls driving of the exhaust fans Ef when a toner image is formed on a sheet St. This control will be described later in the description of a method for controlling the image forming apparatus 1.

### Operation Unit 80

The operation unit 80 is for activating and stopping the image forming apparatus 1, and for inputting settings of an image formation job to be executed by the image forming apparatus 1. The operation unit 80 may be operation keys including a power switch formed on the upper surface of the housing 100, or may be a touch screen formed on the display surface of a display unit., for example. Alternatively, the operation unit 80 may be an external device such as a personal computer connected to the image forming apparatus 1.

### Method for Controlling the Image Forming Apparatus 1

Next, a method for controlling the image forming apparatus 1 described above is explained. FIG. 3 is a diagram for explaining the method for controlling the image forming apparatus 1 according to the first embodiment. This diagram is a graph showing the temporal blowing capacities [pw] of the air supply fans Af and the exhaust fans Ef installed in the image forming apparatus 1 described with reference to FIGS. 1 and 2. In the graph in FIG. 3, the total blowing capacity of the air supply fans Af is indicated by a dashed line. Also, in the graph in FIG. 3, the total blowing capacity of the exhaust fans Ef is indicated by a solid line.

Further, in FIG. 3, each period during which the image forming apparatus 1 has been powered on and is in an activated state, but any image formation job is not being executed is a waiting period [Tw]. The respective periods during which the image forming apparatus 1 is executing an image formation job are job periods [T1] through [T3].

The control method to be described below with reference to the graph in FIG. 3 described above is the procedures to be carried out by the controller 70 of the image forming apparatus 1 to operate the air supply fans Af and the exhaust fans Ef, and is implemented by the CPU of the controller 70 executing a program recorded on the ROM or the RAM. In the description below, the method for controlling the image forming apparatus 1 will be described on the basis of the graph in FIG. 3, with reference to FIGS. 1 and 2.

### Control During Waiting Periods [Tw]

During each waiting period [Tw], the controller 70 controls the heating control means of the heating roller 41 in the fixing device 40, so that the heating roller 41 is heated. The controller 70 also drives the exhaust fans Ef, so that the air around the fixing device 40 is exhausted, and the heat around the fixing device 40 is released to the outside of the housing 100. Thus, the heating roller 41 is maintained at a predetermined heating temperature.

Meanwhile, the controller 70 does not drive the components other than the heating control means of the heating roller 41 and the exhaust fans Ef. In other words, the controller 70 does not drive the image former 20, the transferrer 30, the sheet feeder 50, the driving roller 43 of the fixing device 40, and the air supply fans Af, but maintains these components in a stopped state.

In this case, the controller 70 adjusts the output of each exhaust fan Ef and drives each exhaust fan Ef, so that a first blowing capacity [P1] that is set for each waiting period [Tw] of the image forming apparatus 1 is achieved. The first blowing capacity [P1] is the blowing capacity as the temperature adjusting exhaust gas necessary for keeping the heating roller 41 of the fixing device 40 within a predetermined temperature range. Such a first blowing capacity [P1] should have a lower value than the value obtained by combining the maximum values of the blowing capacities of the respective exhaust fans Ef.

To obtain such a first blowing capacity [P1], the controller 70 drives only either the internal exhaust fan Ef1 or the ceiling exhaust fan Ef2 so as to have the first blowing capacity [P1], while maintaining the other exhaust fan in a stopped state. Alternatively, the controller 70 may drive both the internal exhaust fan Ef1 and the ceiling exhaust fan Ef2 so that the total blowing capacity in a case where both the internal exhaust fan Ef1 and the ceiling exhaust fan Ef2 are driven becomes the first blowing capacity [P1].

### Control During Job Periods [T1] through [T31 ]

During the job periods [T1] through [T3], the controller 70 controls the heating control means of the heating roller 41 in the fixing device 40, so that the heating of the heating roller 41 is continued. The controller 70 also controls driving of the image former 20, the transferrer 30, the sheet feeder 50, and the driving roller 43 of the fixing device 40, in accordance with the settings of the image formation job input from the operation unit 80. In this manner, toner images are formed on the set number of sheets St.

At this time, the controller 70 also controls driving of the air supply fans Af and the exhaust fans Ef, in accordance with the job settings. Here, the job settings are the number of sheets St to be processed, and the rigidity of the sheets St to be processed, for example. In the description below, the control to be performed by the controller 70 on the air supply fans Af and the exhaust fans Ef during the respective job periods [T1] through [T3] having different job settings will be explained.

### First Job Period [T1]

During the first job period [T1], the controller 70 executes an image formation job for processing a predetermined number or more of sheets St having low rigidity, for example, in accordance with an operation at the operation unit 80.

Here, a sheet St having low rigidity is a sheet St having a rigidity equal to or lower than a predetermined value, due to a thickness as small as a preset value and a material having no rigidity. Such a sheet St having low rigidity easily adsorbs to the fixing belt 43a of the fixing device 40. Therefore, it is necessary to separate the sheet St from the fixing belt 43a with air blown from the separation fan Af1.

The predetermined number of sheets is the minimum number of sheets that can cause a rise in the temperature in the housing 100, as the air supply fans Af are driven. That is, in a case where air is supplied into the housing 100 by driving of the air supply fans Af, if the exhaust amount in the housing 100 is insufficient, heat accumulates in the housing 100, leading to a rise in the temperature in the housing 100. However, it takes a considerable amount of time from the start of driving of the air supply fans Af until the temperature inside the housing 100 starts to rise. Therefore, the temperature in the housing 100 does not rise until the number of processed sheets reaches the minimum number that causes a temperature rise. The minimum number of processed sheets is set as the predetermined number.

During the first job period [T1], the controller 70 starts driving all the air supply fans M stopped during the waiting period [Tw]. That is, the controller 70 starts driving the separation fan Af1, the sheet cooling fan Aft, and the cleaning unit cooling fan Af3. The driving of these air supply fans Af is performed at a timing according to a preset program.

The controller 70 further increases the blowing capacity of the exhaust fans Ef that were driven with the first blowing capacity [P1] during the waiting period [Tw], and changes the blowing capacity of the exhaust fans Ef to a second blowing capacity [P2]. The second blowing capacity [P2] is the value obtained by adding the total blowing capacity [pd] generated by driving the air supply fans Af during the first job period [T1], to the first blowing capacity [P1]. With this arrangement, the pressure in the housing 100, or particularly, the pressure around the fixing device 40, is maintained at the same level as that during the waiting period [Tw], and the heating roller 41 of the fixing device 40 is maintained within a predetermined temperature range.

To obtain such a second blowing capacity [P2], the controller 70 drives both the internal exhaust fan Ef1 and the ceiling exhaust fan Eft. The controller 70 also increases the blowing capacity of the exhaust fans Ef at the same time as the start of the first job period [T1], which is the same time as the start of the driving of the air supply fans Af, or thereafter. In this case, the blowing capacity of the exhaust fans Ef should be increased during the period from the start of the driving of the air supply fans Af until the start of the temperature rise in the housing 100.

### Second Job Period [T2]

During the second job period [T2], the controller 70 executes an image formation job for processing less than the predetermined number of sheets St having low rigidity, for example, in accordance with an operation at the operation unit 80.

In this case, the controller 70 starts driving all the air supply fans Af stopped during the waiting period [Tw] immediately before the second job period [T2]. That is, the controller 70 starts driving the separation fan Af1, the sheet cooling fan Af2, and the cleaning unit cooling fan Af3. This is the same as in the case of the first job period [T1].

Meanwhile, the controller 70 maintains the outputs of the exhaust fans Ef at the same first blowing capacity [P1] as that during the waiting period [Tw]. Here, the air supply fans Af are driven to supply air into the housing 100, but the number of sheets St to be processed is smaller than the predetermined number. Therefore, even if the exhaust amount becomes temporarily insufficient, the temperature in the housing 100 does not rise. Therefore, the blowing capacity of the exhaust fans Ef should be maintained at the same first blowing capacity [P1] as that during the waiting period [Tw].

### Third Job Period [T3]

During the third job period [T3], the controller 70 executes an image formation job for processing a predetermined number or more of sheets St having a rigidity that is equal to or higher than a predetermined rigidity, in accordance with an operation at the operation unit 80.

In this case, the controller 70 starts driving the sheet cooling fan Af2 and the cleaning unit cooling fan Af3 among the air supply fans M that were stopped during the waiting period [Tw], and keeps the separation fan Af1 stopped. The sheet cooling fan Af2 and the cleaning unit cooling fan Af3 are driven at a timing according to a preset program. Further, as the sheets St have rigidity, each sheet St is easily separated from the fixing belt 43a of the fixing device 40, and there is no need to drive the separation fan Af1.

Meanwhile, the controller 70 maintains the outputs of the exhaust fans Ef at the same first blowing capacity [P1] as that during the waiting period [Tw]. Here, the sheet cooling fan Af2 and the cleaning unit cooling fan Af3 are driven, to supply air into the housing 100. However, not enough heat accumulates in the housing 100 due to an insufficient exhaust amount, and a temperature rise is not caused.

During the third job period [T3], the blowing capacity of the exhaust fans Ef may be increased from the first blowing capacity [P1] of the waiting period [Tw] by the amount equivalent to the total blowing capacity in a case where the sheet cooling fan Af2 and the cleaning unit cooling fan Af3 are driven.

In addition to the control during the respective job periods [T1] through [T3] as described above, the controller 70 may increase the blowing capacity of the exhaust fans Ef from the first blowing capacity [P1] of the waiting period [Tw] in a case where the total blowing capacity of the air supply fans Af has reached a predetermined blowing capacity. In this case, the amount of increase in the blowing capacity of the exhaust fans from the first blowing capacity [P1] is limited to the amount equivalent to the total blowing capacity of the air supply fans Af.

The controller 70 may further drive the exhaust fans Ef, in accordance with the temperature information from the temperature sensor 60, as well as the drive states of the air supply fans Af. In this case, when the temperature in the housing 100 measured by the temperature sensors 60 reaches a predetermined value, the blowing capacity of the exhaust fans Ef is increased from the first blowing capacity [P1] of the waiting period [Tw].

Further, in a case where the difference between the temperatures in the housing 100 measured by the temperature sensors 60 disposed at two locations exceeds a predetermined temperature difference (10° C., for example), the blowing capacity of the internal exhaust fan Ef1 or the ceiling exhaust fan Ef2 may be increased so that the difference in the temperature in the housing 100 is eliminated. As a result, the blowing capacity of the exhaust fans Ef increases from the first blowing capacity [P1] of the waiting period [Tw].

### Effects of the First Embodiment

According to the first embodiment described above, in a case where the air supply fans Af are driven in accordance with the job settings, the blowing capacity of the exhaust fans Ef is increased, so that the heat in the housing 100 is released without staying in the housing 100. Thus, a rise in the temperature in the housing 100 can be prevented. As a result, it becomes possible to prevent defects, such as damage to electronic components due to a rise in the temperature in the housing 100, and toner melting on the image bearing surface 31a of the intermediate transfer belt 31 or in the cleaning unit 35.

### Second Embodiment

### Configuration of an Image Forming Apparatus

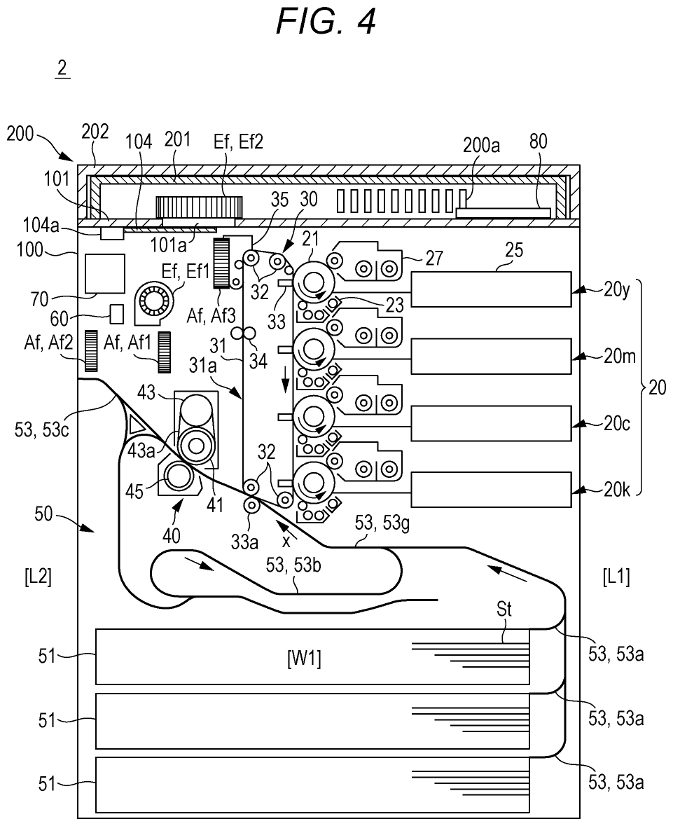

FIG. 4 is a schematic configuration diagram of an image forming apparatus 2 according to a second embodiment as viewed from the front side [W1]. The front side [W1] is the side facing the operator who operates the image forming apparatus 2. The image forming apparatus 2 of the second embodiment shown in this drawing differs from the image forming apparatus 1 of the first exemplary embodiment in that the opening 101a in the top panel 101 is equipped with a shutter 104. The other components are the same as those of the image forming apparatus 1 of the first embodiment.

The shutter 104 includes an opening/closing drive unit 104a, and can freely open and close the opening 101a. To save the installation space, the opening/closing drive unit 104a of the shutter 104 is preferably a solenoid, but may be a drive unit using an electric motor.

In the image forming apparatus 2 having such a configuration, the controller 70 controls the blowing capacity of the ceiling exhaust fan Ef2, depending on the opened/closed state of the shutter 104.

### Method for Controlling the Image Forming Apparatus 2

A method for controlling the image forming apparatus 2 as described above may be the same as the method for controlling the image forming apparatus 1 of the first embodiment. However, the ceiling exhaust fan Ef2 is constantly driven, and the blowing capacity of the ceiling exhaust fan Ef2 is controlled through control on the opened/closed state of the shutter 104.

### Effects of the Second Embodiment

With the second embodiment described above, it is also possible to achieve the same effects as those of the first embodiment. Further, according to the second embodiment, the control on the blowing capacity of the ceiling exhaust fan Ef2 is performed through control on the opened/closed state of the shutter 104. Thus, the air release from the inside of the housing 100 with the ceiling exhaust fan Ef2 can be performed with excellent responsiveness to the control being performed by the controller 70.

### Third Embodiment

### Configuration of an Image Forming Apparatus

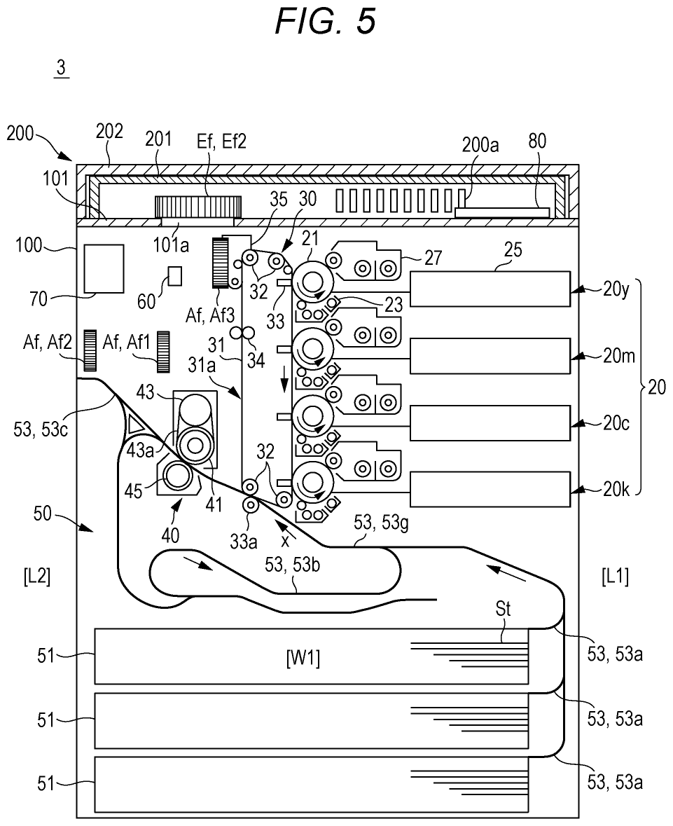

FIG. 5 is a schematic configuration diagram of an image forming apparatus 3 according to a third embodiment as viewed from the front side [W1]. The front side [W1] is the side facing the operator who operates the image forming apparatus 3. The image forming apparatus 3 of the third embodiment shown in the drawing differs from the image forming apparatus 1 of the first embodiment in that the ceiling exhaust fan Ef2 disposed over the opening 101a in the top panel 101 of the housing 100 is the only exhaust fan Ef disposed near the fixing device 40, and any exhaust fan Ef is not disposed inside the housing 100. The other components are the same as those of the image forming apparatus 1 of the first embodiment.

Like the ceiling exhaust fan Ef2 of the first embodiment, the ceiling exhaust fan Ef2 is not necessarily disposed to face the opening 101a in the top panel 101, as long as the air taken in through the opening 101a can be released through the exhaust holes 200a, with the ceiling housing 200 being used as the duct. Further, the blowing capacity of the ceiling exhaust fan Ef2 can be adjusted stepwise, and the maximum value of the blowing capacity is the maximum blowing capacity [P2] shown in FIG. 3.

Note that a plurality of ceiling exhaust fans Ef2 may be provided, as in the first embodiment. In this case, the blowing capacity of the ceiling exhaust fans Ef2 may be adjusted stepwise through control on driving of the ceiling exhaust fans Ef2.

### Method for Controlling the Image Forming Apparatus 3

A method for controlling the image forming apparatus 3 described above may be the same as the method for controlling the image forming apparatus 1 of the first embodiment. However, the controller 70 achieves the air release described above with reference to FIG. 3, by controlling the blowing capacity of one ceiling exhaust fan Ef2 stepwise, controlling turning on/off of a plurality of ceiling exhaust fans Ef2, or controlling the respective blowing capacities of the ceiling exhaust fans Ef2 stepwise.

### Effects of the Third Embodiment

With the third embodiment described above, it is also possible to achieve the same effects as those of the first embodiment. Note that the third embodiment can be implemented in combination with the second embodiment, and the opening 101a in the top panel 101 may be equipped with a shutter so that the effects of the second embodiment can also be achieved.

### Fourth Embodiment

### Configuration of an Image Forming Apparatus

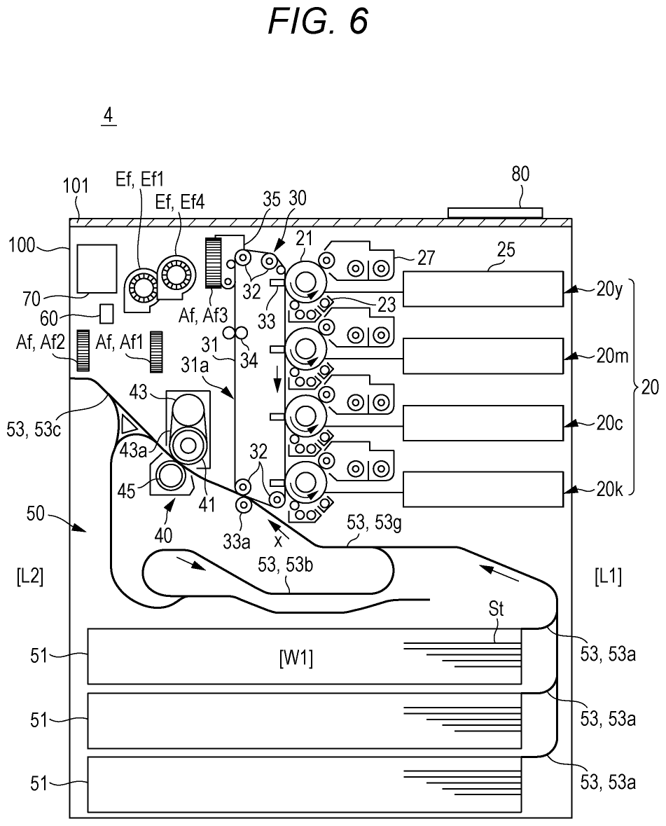

FIG. 6 is a schematic configuration diagram of an image forming apparatus 4 according to a fourth embodiment as viewed from the front side [W1]. The front side [W1] is the side facing the operator who operates the image forming apparatus 4. The image forming apparatus 4 of the fourth embodiment shown in the drawing differs from the image forming apparatus 1 of the first embodiment in that the exhaust fans Ef disposed near the fixing device 40 are disposed only in the housing 100, but are not provided on the top surface of the housing 100. The other components are the same as those of the first embodiment. Since any exhaust fan Ef is not provided on the top surface of the housing 100, the top panel 101 of the housing 100 does not need to have an opening, and this embodiment also differs from the first embodiment in that a ceiling housing is not provided on top of the housing 100.

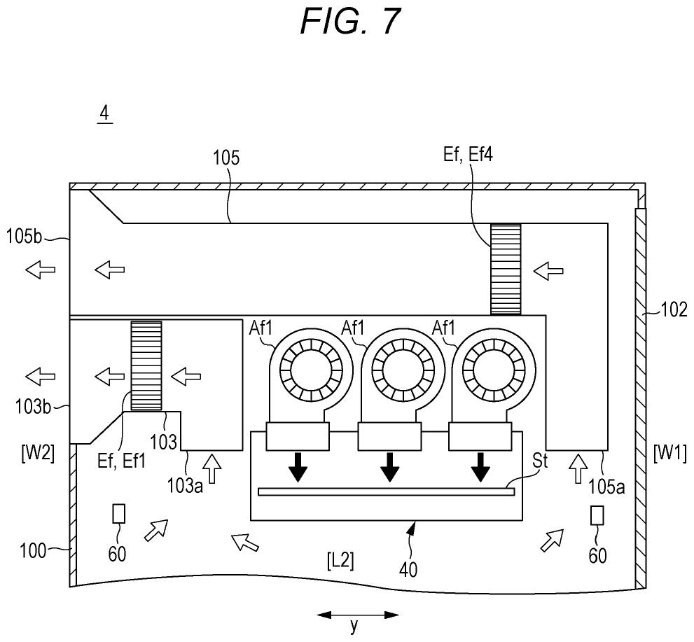

FIG. 7 is a configuration diagram of the relevant components of the image forming apparatus 4 of the fourth embodiment as viewed from the sheet ejection side [L2], and is a diagram for explaining the layout of the exhaust fans Ef. In FIG. 7, the right-hand side of the housing 100 is the front side [W1] of the housing 100, and is the side on which a door 102 is formed. Also, in FIG. 7, the left-hand side of the housing 100 is the opposite side from the front side [W1], and is the back side [W2] of the housing 100. The direction from the front side [W1] toward the back side [W2] is the conveyance width direction y perpendicular to the conveyance direction x of the sheet St. FIG. 7 also shows part of ducts 103 and 105, which are not shown in FIG. 6, and indicates the airflow with arrows. In the description below, the configurations of the exhaust fans Ef are explained, with reference to FIGS. 6 and 7.

The exhaust fans Ef are fans for exhausting the air in the housing 100 of the image forming apparatus 4 to the outside of the housing 100. Such exhaust fans Ef are provided in the housing 100, and are an internal exhaust fan Ef1 disposed near the fixing device 40 and an additional exhaust fan Ef4. A plurality of internal exhaust fans Ef1 and a plurality of additional exhaust fans Ef4 may be provided.

The internal exhaust fan Ef1, which is one of the exhaust fans Ef, is the same as the internal exhaust fan Ef1 described in the first embodiment. In the housing 100, the internal exhaust fan Ef1 is disposed at one end of the conveyance width direction y perpendicular to the conveyance direction x of the sheet St, and on the back side [W2] of the housing 100. The internal exhaust fan Ef1 is disposed at the middle of the duct 103 as shown in the drawing, for example, or is disposed at an end of the duct 103, to exhaust the air around the fixing device 40 from the housing 100.

Specifically, the duct 103 equipped with the internal exhaust fan Ef1 has an air intake end 103a disposed near the back side [W2] of the fixing device 40 in the housing 100. The duct 103 also has an air release end 103b located in the surface of the housing 100 on the back side [W2] so as to communicate with the outside of the housing 100. With this arrangement, in a case where the internal exhaust fan Ef1 is driven, the air near the fixing device 40 is sucked from the back side [W2] of the housing 100, and is released to the outside of the housing 100.

The internal exhaust fan Ef1 disposed in this manner preferably has a blowing capacity that can be adjusted stepwise, but does not necessarily have such a blowing capacity.

The additional exhaust fan Ef4, which is the other one of the exhaust fans Ef, is disposed at the other end of the conveyance width direction y perpendicular to the conveyance direction x of the sheet St in the housing 100, and on the front side [W1] of the housing 100. The additional exhaust fan Ef4 is disposed at the middle of the duct 105 as shown in the drawing, for example, or is disposed at an end of the duct 105, to exhaust the air around the fixing device 40 from the housing 100.

Specifically, the duct 105 equipped with the additional exhaust fan Ef4 has an air intake end 105a disposed near the front side [W1] of the fixing device 40 in the housing 100. The duct 105 also has an air release end 105b located in the surface of the housing 100 on the back side [W2] so as to communicate with the outside of the housing 100. With this arrangement, in a case where the additional exhaust fan Ef4 is driven, the air near the fixing device 40 is sucked from the front side [W1] of the housing 100, and is released to the outside of the housing 100.

The additional exhaust fan Ef4 disposed in this manner preferably has a blowing capacity that can be adjusted stepwise, but does not necessarily have such a blowing capacity.

Note that the additional exhaust fan Ef4 can be installed at any location inside the housing 100, as long as the air intake end 105a is disposed near the front side [W1] of the fixing device 40 in the housing 100. The installation position of the additional exhaust fan Ef4 is on the front side [W1] of the housing 100, and may be above or below the fixing device 40, on the sheet supply side [L1], or on the sheet ejection side [L2]. Further, the installation position is not necessarily on the front side [W1] of the housing 100, either.

### Method for Controlling the Image Forming Apparatus 4

A method for controlling the image forming apparatus 4 described above may be the same as the method for controlling the image forming apparatus 1 of the first embodiment, and the control on the blowing capacity of the additional exhaust fan Ef4 should be performed in the same mariner as the control on the blowing capacity of the ceiling exhaust fan Eft according to the first embodiment.

### Effects of the Fourth Embodiment

With the fourth embodiment described above, it is also possible to achieve the same effects as those of the first embodiment. In a modification of the fourth embodiment, only the internal exhaust fan Ef1 may be provided as the exhaust fan Ef, for example. In this case, one internal exhaust fan Ef1 or a plurality of internal exhaust fans Ef1 may be provided, as long as the blowing capacity can be controlled stepwise as described in the first embodiment.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
an image former that forms a toner image;
a fixing device that fixes the toner image to a sheet onto which the toner image formed by the image former has been transferred;
a housing that houses the image former and the fixing device;
an air supply fan that supplies air into the housing;
an exhaust fan that exhausts air from the housing; and
a hardware processor that controls driving of the image former, the fixing device, the air supply fan, and the exhaust fan, wherein
when the driving of the air supply fan is changed, the hardware processor changes a blowing capacity of the exhaust fan in accordance with the change in the driving of the air supply fan.

2. The image forming apparatus according to claim 1, wherein
the hardware processor increases the blowing capacity of the exhaust fan by an amount corresponding to a blowing capacity of the air supply fan, the blowing capacity of the air supply fan having increased with the change in the driving of the air supply fan.

3. The image forming apparatus according to claim 1, wherein
the hardware processor increases the blowing capacity of the exhaust fan after starting the driving of the air supply fan.

4. The image forming apparatus according to claim 1, wherein
the fixing device includes a heating roller,
the hardware processor
puts the heating roller into a heated state, and adjusts temperature of the heating roller by driving the exhaust fan, during a waiting period for waiting for execution of a job by driving of the image former and the fixing device, and
drives the air supply fan and increases the blowing capacity of the exhaust fan, during a job period for executing the job.

5. The image forming apparatus according to claim 4, wherein,
on a basis of settings of the job, the hardware processor determines whether to increase the blowing capacity of the exhaust fan during the job period.

6. The image forming apparatus according to claim 5, wherein,
when the job period based on the settings of the job is shorter than a predetermined time, the hardware processor determines not to increase the blowing capacity of the exhaust fan during the job period.

7. The image forming apparatus according to claim 4, wherein
a plurality of air supply fans is provided as the air supply fan, and,
during the job period, the hardware processor drives at least one air supply fan of the plurality of air supply fans on a basis of settings of the job, and determines whether to increase the blowing capacity of the exhaust fan during the job period with the air supply fan being driven during the job period.

8. The image forming apparatus according to claim 7, wherein,
when all of the plurality of air supply fans is driven during the job period, the hardware processor increases the blowing capacity of the exhaust fan during the job period.

9. The image forming apparatus according to claim 7, further comprising
a transferrer that transfers the toner image formed by the image former onto the sheet, wherein
the plurality of air supply fans includes:
a separation fan that supplies air to separate the sheet from the fixing device by blowing air;
a sheet cooling fan that supplies air to cool the sheet that has passed through the fixing device by blowing air; and
a cooling fan that supplies air to cool the transferrer by blowing air.

10. The image forming apparatus according to claim 1, wherein
a plurality of exhaust fans is provided as the exhaust fan, and,
when driving of the air supply fan is started while a group of exhaust fans of the plurality of exhaust fans is driven, the hardware processor increases the blowing capacity by driving the other group of exhaust fans of the plurality of exhaust fans.

11. The image forming apparatus according to claim 10, wherein
a plurality of air supply fans is provided as the air supply fan, and
a sum of maximum blowing capacities of the other group of exhaust fans is not smaller than a sum of maximum blowing capacities of the plurality of air supply fans.

12. The image forming apparatus according to claim 1, wherein
a plurality of exhaust fans capable of adjusting the blowing capacity stepwise is provided as the exhaust fan, and,
when the air supply fan is driven, the hardware processor increases the blowing capacity by controlling the blowing capacity of the plurality of exhaust fans.

13. The image forming apparatus according to claim 10, wherein
the housing has a door in surface on one side in a conveyance width direction perpendicular to a conveyance direction of the sheet, and
one exhaust fan of the plurality of exhaust fans is disposed on a back side that is the opposite side from the door, and an air intake end is disposed on the back side, to exhaust air from the housing.

14. The image forming apparatus according to claim 13, wherein
one exhaust fan of the plurality of exhaust fans is disposed on a side of the door, and an air intake end is disposed on the side of the door, to exhaust air from the housing.

15. The image forming apparatus according to claim 14, further comprising
a temperature sensor that measures temperature on the side of the door and temperature on the back side in the housing, wherein
the hardware processor controls driving of the plurality of exhaust fans, on a basis of a difference between the temperature on the side of the door and the temperature on the back side, the temperature on the side of the door and the temperature on the back side having been detected by the temperature sensor.

16. The image forming apparatus according to claim 10, wherein
the housing has an opening in a top panel,
one exhaust fan of the plurality of exhaust fans is disposed in the housing, and
one exhaust fan of the plurality of exhaust fans is disposed on the top panel, and exhausts air from the housing through the opening.

17. The image forming apparatus according to claim 16, wherein
a shutter that can be freely opened and closed is provided over the opening in the top panel, and
the hardware processor controls the blowing capacity of the exhaust fan disposed on the top panel, by opening and closing the shutter.

18. The image forming apparatus according to claim 1, wherein the exhaust fan is a single exhaust fan whose blowing capacity can be adjusted stepwise.

19. The image forming apparatus according to claim 18, wherein
the housing has a door in a surface on one side in a conveyance width direction perpendicular to a conveyance direction of the sheet, and
the exhaust fan is disposed on a back side that is the opposite side from the door.

20. A method for controlling an image forming apparatus that includes:
an image former that forms a toner image;
a fixing device that fixes the toner image to a sheet onto which the toner image formed by the image former has been transferred;
a housing that houses the image former and the fixing device;
an air supply fan that supplies air into the housing; and
an exhaust fan that exhausts air from the housing,
the method comprising
increasing a blowing capacity of the exhaust fan, when the air supply fan is driven.
